(19) United States
(12) Patent Application Publication
(10) Pub. No.: US 2026/0278354 A1
(43) Pub. Date: Sep. 17, 2026

(54) BLOCK-WISE KNOWLEDGE DISTILLATION FOR POST-TRAINING QUANTIZATION

(71) Applicant: QUALCOMM Incorporated, San Diego, CA (US)

(72) Inventors: Jung Hyun LEE, Seoul (KR); Minseop PARK, San Diego, CA (US); Jaeseong YOU, Seoul (KR)

(21) Appl. No.: 19/298,092

(22) Filed: Aug. 12, 2025

Related U.S. Application Data
(60) Provisional application No. 63/771,916, filed on Mar. 14, 2025.

(51) Int. Cl. G06N 3/0495

(52) U.S. Cl. CPC G06N 3/0495

(57) ABSTRACT

Techniques for generating content are described. In an example, a device includes a memory and a processor coupled to the memory. The processor may be configured to obtain unquantized weights associated with one or more blocks of a trained machine learning model and process the unquantized weights to generate quantized weights. Each quantized weight of the quantized weights may be a function of a quantization step size, a corresponding unquantized weight, one or more weight-clipping threshold values, a weight-scaling matrix, and/or a weight-scaling factor. The processor is configured to process, using the trained machine learning model with the quantized weights, input data to generate output content.

### CROSS REFERENCE TO RELATED APPLICATIONS

This application claims priority to U.S. Provisional Application No. 63/771,916, filed Mar. 14, 2025, the content of which is incorporated herein by reference in its entirety for all purposes.

### TECHNICAL FIELD

The disclosure relates generally to machine learning models. For example, aspects of the present disclosure include systems and techniques for performing block-wise knowledge distillation for post-training quantization (PTQ), such as through adaptive scaling.

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A generative machine learning system can process data to generate desired output content from an input (e.g., a natural language input, input image(s) or video(s), a noise input such as for diffusion models, etc.). For instance, a language-based generative machine learning model (e.g., a large language model (LLM)) can generate natural language responses from natural language inputs and can incorporate various forms of data, such as audio, images and text. In some cases, a generative machine learning system can include an encoder that processes input features to generate output features (also referred to as embeddings or encodings) and can use the output features to generate relevant output content in a given form (e.g., in a natural language form, as generated images and/or video, as audio, explanation of the content, etc.).

A generative ML system can perform a wide range of tasks such as answering questions, providing explanations, generating creative content, assisting with coding, and offering recommendations. Various tools may be connected to the generative ML system to allow interaction with external systems, such as browsing the Internet, generating images, executing code, etc. Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for generating content is provided. The apparatus includes: at least one memory and at least one processor coupled to the at least one memory and configured to: obtain unquantized weights associated with one or more blocks of a trained machine learning model; process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and process, using the trained machine learning model with the quantized weights, input data to generate output content.

In some aspects, a method for generating content is provided. The method includes: obtaining unquantized weights associated with one or more blocks of a trained machine learning model; processing the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and processing, using the trained machine learning model with the quantized weights, input data to generate output content.

In some aspects, a non-transitory computer-readable medium is provided that has stored thereon instructions that, when executed by one or more processors, cause the one or more processors to: obtain unquantized weights associated with one or more blocks of a trained machine learning model; process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and process, using the trained machine learning model with the quantized weights, input data to generate output content.

In some aspects, an apparatus for generating content is provided. The apparatus includes: means for obtaining unquantized weights associated with one or more blocks of a trained machine learning model; means for processing the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and means for processing, using the trained machine learning model with the quantized weights, input data to generate output content.

In some aspects, one or more of the apparatuses described herein is, is part of, and/or includes a mobile device (e.g., a mobile telephone or other mobile devices) or other wireless communication device, a vehicle or a computing device or component of a vehicle, an extended reality (XR) device or system (e.g., a virtual reality (VR) device, an augmented reality (AR) device, or a mixed reality (MR) device), a wearable device, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 illustrates an example implementation of a system, which may include a central processing unit (CPU), configured to perform one or more of the functions described herein;

FIG. 2 is a block diagram illustrating a multimodal generative machine learning system for generating natural language responses based on natural language input from a prompt, in accordance with aspects of the disclosure;

FIG. 3 is a block diagram illustrating a generative response engine configured for multimodal input and output, in accordance with aspects of the disclosure;

FIG. 4 is a block diagram of a system for quantization of weights of a machine learning model, in accordance with aspects of the disclosure;

FIG. 5 is a block diagram of a system for quantization of weights of multiple blocks of a machine learning model, in accordance with aspects of the disclosure;

FIG. 6 is a flow diagram illustrating an example of a process for quantization of weights of machine learning models, in accordance with aspects of the disclosure;

FIG. 7 is a block diagram of an example transformer in accordance with aspects of the disclosure; and

FIG. 8 shows an example of a computing system, which may be for example any computing device that may implement components of the system.

### DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

While machine learning models (e.g., neural networks) are powerful architectures capable of a wide range of useful tasks, such as recognizing objects in image data, they are likewise highly resource dependent. For example, neural networks may require significant compute, memory, power, and/or time resources for training and/or for inferencing. These resource requirements may significantly limit the ability to train and deploy neural networks to certain types of devices and for certain use cases. For instance, training of machine learning models may be a computationally intensive process that can take a relatively long time, a large quantity of training data, and many operations. As such, in some cases, quantization may be used to help reduce the computation that is required.

Quantization is a method of mapping continuous values to a smaller set of discrete finite values. For example, quantization approximates real-world values (e.g., floating point values) with representative values (e.g., integer values) that limit the precision and range of the original input. When applied to machine learning, such as to a neural network, quantization may significantly reduce resource usage for both training and inferencing. For example, performing massive numbers of integer operations during training of or inferencing with a quantized (e.g., reduced-precision) neural network may be significantly more efficient in terms of resource usage as compared to performing floating point operations with an unquantized (e.g., full-precision) neural network processing the same input data.

Quantization of trained machine learning models allows quantized trained machine learning models to be efficiently deployed on various devices. Quantization may allow a quantized trained machine learning model to perform operations (e.g., at the inference phase of operation) on a device relatively quickly. Quantization may include changing a format of parameters (e.g., weights and activations) of a machine learning model from the format in which the machine learning model was trained to a different format.

Post-training quantization (PTQ) is a process by which a trained machine learning model is quantized. For example, during training, a machine learning model may store parameters (e.g., weights) according to a first format that may allow a high degree of precision. For example, during training, the model may store parameters as floating-point numbers, such as 16-bit floating point numbers, which may be referred to as float16 or FP16, or 32-bit floating point numbers, which may be referred to as float32 or FP32. According to PTQ, after training is performed to generate the trained machine learning model and before the trained machine learning model is deployed onto a device for use by a device, the model may be quantized by, in part, changing the format used to store the parameters of the model from the first format to a second format (e.g., an integer format where the parameters are represented as integer numbers instead of floating point numbers). The second format may use less memory and/or be less computational expensive to use. For example, after quantization, the model may store parameters as integer numbers such as 16-bit integer numbers (which may be referred to as Int16), 8-bit integer numbers (which may be referred to as Int8), 4-bit integer numbers (which may be referred to as Int4), etc. It may be less computationally expensive to store and/or operate using integer numbers than floating point numbers. Thus, a device may conserve power and/or processing time when using a quantized trained machine learning model as compared with using an unquantized trained machine learning model. Accordingly, it may be advantageous to quantize machine learning models.

In various aspects of the present disclosure, the term “quantize,” “quantizing,” and like terms may be used as a verb and may be applied to machine learning models, and/or layers of a trained machine learning model. In such cases the term “quantize,” “quantizing,” and like terms may refer to quantizing parameters (e.g., weights and/or activations) as stored in the of the respective machine learning models and/or layers. For example, a trained machine learning model may include weights (e.g., numerical values). During training, and after training, the weights may be stored in the trained machine learning model in a first format (e.g., float8, float16, float32, float16). Quantizing the trained machine learning model may include changing the weights from the first format to a second format (e.g., Int8).

Further, machine learning models may include activations. Activations can refer to values used as inputs and/or outputs of various functions, operations, and/or layers (or blocks or modules) of the machine learning model. The activations may have a certain format. For example, a function (of a particular layer) may expect to receive values formatted according to the certain format. For instance, the function may read the values from memory according to the certain format. Further, the function may output other values (e.g., based on processing the values read from memory by the function) according to a particular format (which may or may not be the same as the certain format). For instance, the function may write the other values to memory in the particular format. For example, an unquantized trained machine learning model may use FP16 to pass values between functions (e.g., outputting values from one function and reading the values by another function). In some cases, the activations of the machine learning model can also be quantized.

Quantizing numbers can result in a loss of precision. Quantizing parameters or weights of a trained machine learning model can result in degradation of the model. In the present disclosure, the term “error” is used to describe a degree of difference between outputs of an unquantized trained machine learning model and the trained machine learning model after being quantized (given the same inputs). For example, a trained machine learning model may be quantized. The unquantized trained machine learning model may be provided an input, the quantized trained machine learning model may be provided the same input. Outputs of the models may be compared. A degree of difference between the outputs may be described as an error. In some cases, error may be calculated as mean-squared error. An error may be a way to describe degradation of a quantized machine learning model.

Systems, apparatuses, processes (also referred to as methods), and computer-readable media (collectively referred to as “systems and techniques”) are described herein for improved PTQ relating to machine learning models (also referred to as machine learning systems). As discussed, quantization of model parameters or weights may result in an increased error. While various approaches sought to mitigate the increased error, such approaches operate on a layer-by-layer basis and are therefore unable to consider inter-layer dependencies, which can result in decreased post-quantization performance. The systems and techniques described herein can perform block-wise knowledge distillation for PTQ, such as through adaptive scaling. The systems and techniques can thus take into account inter-layer dependencies of various layers of a machine learning model.

Various aspects of the disclosure are discussed in detail below. While specific implementations are discussed, it should be understood that such implementations are described for illustration purposes only. A person skilled in the relevant art will recognize that other components and configurations may be used without parting from the spirit and scope of the disclosure.

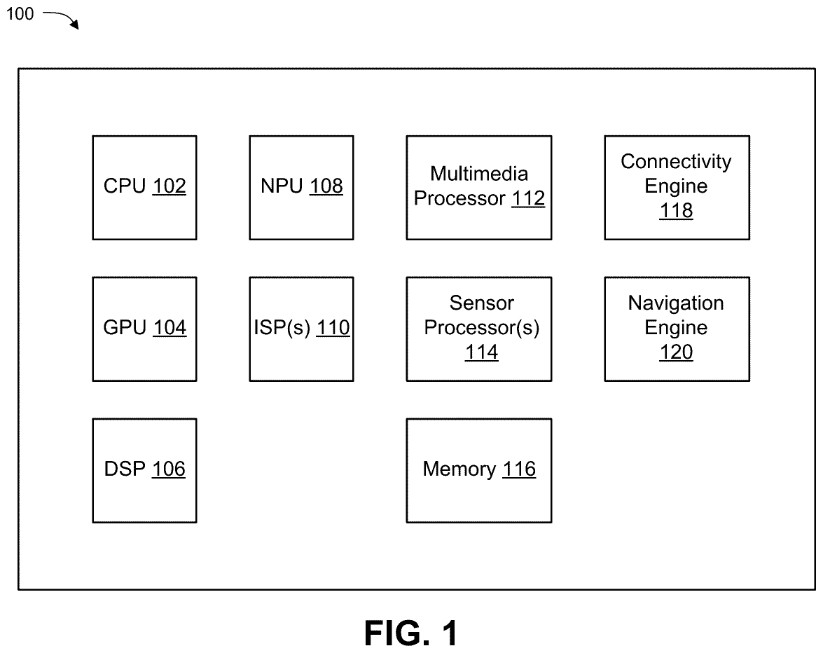

FIG. 1 illustrates an example implementation of a system 100, which may include a central processing unit (CPU), configured to perform one or more of the functions described herein. System 100, which may include a central processing unit (CPU 102) (which may be a multi-core CPU). Parameters or variables (e.g., neural signals and synaptic weights), system parameters associated with a computational device (e.g., neural network with weights), task information, among other information may be stored in a memory block associated with a neural processing unit (NPU 108), in a memory block associated with a CPU 102, in a memory block associated with a graphics processing unit (GPU 104), in a memory block associated with a digital signal processor (DSP 106), in a memory 116, and/or may be distributed across multiple blocks. Instructions executed at the CPU 102 may be loaded from a program memory associated with the CPU 102 or may be loaded from memory 116.

The system 100 may also include additional processing blocks tailored to specific functions, such as the GPU 104, the DSP 106, a connectivity engine 118, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, the DSP 106, and/or the GPU 104. The system 100 may also include one or more sensor processor(s) 114, one or more image signal processors (ISP(s) 110), and/or navigation engine 120, which may include a global positioning system. In some examples, the sensor processor(s) 114 can be associated with or connected to one or more sensors for providing sensor input(s) to the sensor processor(s) 114. For example, the one or more sensors and sensor processor(s) 114 can be provided in, coupled to, or otherwise associated with a same computing device.

The system 100 may be implemented as a system on a chip (SoC). The system 100 may be based on an Advanced Reduced Instruction Set Computer (RISC) Machine (ARM) instruction set. The system 100 and/or components thereof may be configured to perform machine learning techniques according to aspects of the present disclosure discussed herein. For example, the system 100 and/or components thereof may be configured to implement a machine learning model (e.g., a quantized trained machine learning model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. In some examples, an ML system can be a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

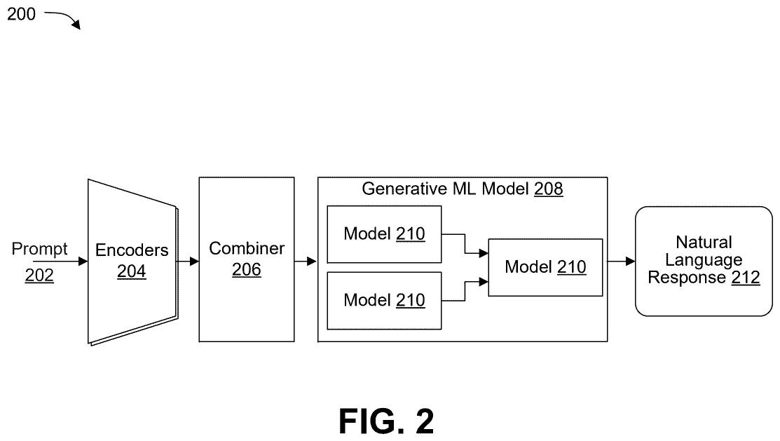

FIG. 2 is a block diagram illustrating a multimodal generative ML system 200 for generating natural language responses based on natural language input from a prompt 202, in accordance with aspects of the disclosure. A multimodal machine learning system is a machine learning model that receives, processes, and outputs data in multiple forms. For example, the input prompt may include text, images, and audio.

For example, the multimodal generative ML system 200 includes encoders 204 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 204) into tokens. In another example, one or more images can be provided to an image encoder (from the encoders 204) that extracts features associated with the image and generates tokens representing the visual features. In another example, audio can be provided to an audio encoder (from the encoders 204) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 206. The combiner 206 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 204. In some aspects, the combiner 206 is configured to concatenate the different tokens in order based on the array to preserve the semantic order of features and provide the tokens to the generative machine learning model 208.

The generative machine learning model 208 is configured to receive the tokens and generate a natural language response 212 based on the tokens and the prompt 202. Generative machine learning model 208 may include one or more models 210 (e.g., transformer neural network(s), diffusion model(s), fully connected layer(s), multilayer perceptrons (MLPs), any combination thereof, and/or other models). The one or more models 210 of the generative machine learning model 208 are configured to process the tokens and extract different types of features that are relevant to the prompt 202. For example, the prompt 202 can be a query for a particular type of information. The one or more models of the generative machine learning model 208 can perform different tasks related to the query, such as writing code to perform a particular function, generating an image based on an input image with expressed modifications, generate an image without any input image, and so forth.

The generative machine learning model 208 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 208), and so forth. The generative machine learning model 208 may also include different types of models and engines to synthesize a coherent contextual output, such as to synthesize the input content and information that is responsive to tasks embedded within the text. For example, the generative machine learning model 208 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 208 may also include a predictive output generation engine to generate multiple responses that are potentially relevant and coherent with respect to the prompt 202. The generative machine learning model 208 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 208 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 208 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 208 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

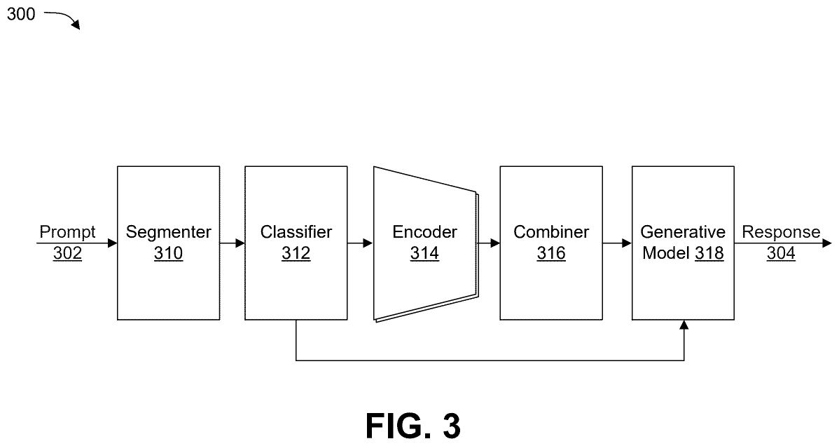

FIG. 3 is a conceptual block diagram of a generative response engine 300 configured for multimodal input and output, in accordance with some aspects of the disclosure. In some aspects, the generative response engine 300 is configured to receive a prompt 302 (e.g., from a user, an application programming interface (API) request, etc.) and perform various processing to generate a response 304 that is responsive to the prompt 302 that is contextually accurate. In some aspects, the prompt 302 may be an array of primitive values, such as text, binary data (byte arrays, etc. For example, the prompt may be a union type that combines different types of primitive data (e.g., string uint8array in JavaScript).

The generative response engine 300 includes a generative machine learning model 318. In some aspects, the generative response engine 300 includes a plurality of adapters (e.g., LoRA) that are trained to improve performance of a base machine learning model (also referred to as a base model) of the generative response engine 300 during inference. The plurality of adapters can be trained to perform different tasks. For example, a first adapter may be trained to perform a first task, and a second adapter a second task and so forth. In this manner, the independently trained adapters are configured to prevent the generative response engine 300 from defaulting to the application of the base model's weights (which can be referred to as base weights) and allow the combination of the base model and the adapters to accurately provide specialized responses that correspond to the fine tuning.

The generative response engine 300 includes various components, such as a segmenter 310, a classifier 312, encoders 314, a combiner 316, and the generative machine learning model 318. The segmenter 310 is configured to segment different content into different portions based on various limitations, such as text size, image size, and so forth. In some cases, the segmenter 310 may also reduce the scope of content (e.g., by reducing a size of an input image) based on limitations of one or more machine learning models of the generative response engine 300. For example, the machine learning model(s) may be trained on a particular size input to extract important features. The segmenter 310 may also segment text into different chunks, such as into individual sentences or paragraphs.

In some aspects, the classifier 312 may be configured to classify the input. For example, the classifier 312 may be configured to generate embeddings that represent features associated with the input (e.g., segmented text, images, etc.) in a vector space. An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings can be learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects. In some aspects, the classifications are provided to the generative machine learning model 318 to activate specific learned domains.

In some cases, the classifier 312 may be configured to classify the input based on a plurality of clusters. The plurality of clusters may represent different semantic spaces for the operation of the generative response engine 300. The plurality of clusters may be related to different specialized tasks, data, or other operations and represent different domains of the generative response engine 300. For example, a generative model trained for customer service may need to learn different domains of knowledge, such as identification of products or services, accounting and billing information, a corpus of documents to help diagnose problems or provide information, and so forth. The plurality of clusters can be determined based on the input and output from the generative response engine 300.

In some cases, the classifier 312 may generate a probability for the prompt 302 (e.g., for each cluster) based on the output from the segmenter 310. The probability represents a likelihood that the prompt 302 is associated with features (e.g., features in a corresponding cluster). In some aspects, the classifier 312 provides the probabilities associated with each cluster and the embeddings to the generative machine learning model 318.

The segmented portions of the prompt 302 can then be provided as input to encoders 314 (e.g., the encoders 204 in FIG. 2) to extract various features and generate tokens associated with those features. In some aspects, each encoder 314 is configured for a different modality or different type of input. For example, the generative response engine 300 may include an encoder 314 for encoding text, an encoder 314 for encoding images, an encoder 314 for encoding audio, etc. There may be additional encoders based on the different modalities. For example, there may be an encoder 314 for handling different types of documents (e.g., PDF, etc.).

The combiner 316 (e.g., the combiner 206 in FIG. 2) receives the tokens from the encoders 314 and synthesizes tokens that represent the prompt 302. For example, the combiner 316 can be configured to concatenate the tokens from the encoders 314 in the correct order to preserve the semantic context of the content. In some cases, the encoders 314 may be configured to execute the encoding operations in parallel and because different content may be encoded at different rates, the tokens may be received out of order. The combiner 316 may receive information (e.g., from the segmenter 310 and/or from the encoders 314) to identify how to sequence the embeddings into an input suitable for the generative machine learning model 318 (e.g., an array of tokens).

In some aspects, the generative machine learning model 318 is configured to use the embeddings during inference to begin inference operation based on the prompt 302. In some aspects, the probabilities from the classifier 312 can be used by the generative machine learning model 318 to activate at least one adapter based on the probability associated with that adapter. In some aspects, because the adapters are tuned independently based on clustered data, the adapters provide a stronger response based on the identification of features that more accurately represent that different classification.

The generative machine learning model 318 may be configured to synthesize the response 304 based on the probabilities provided by the classifier 312 and the generative machine learning model 318.

As noted previously, the systems and techniques described herein relate to improved approaches for performing quantization of machine learning model parameters, such as weights, activations, etc. Such techniques reduce a need for computational resources, while minimizing performance degradation due to error or noise resulting from the quantization. As described herein, the systems and techniques can perform block-wise knowledge distillation for post-training quantization (PTQ) (e.g., through adaptive scaling).

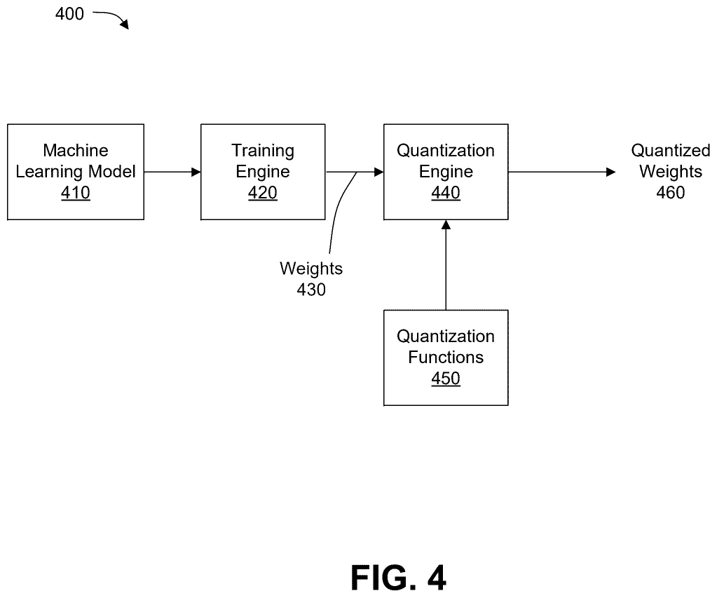

FIG. 4 is a block diagram of a system 400 for quantization of weights of a machine learning model, in accordance with aspects of the disclosure. In the example depicted in system 400, a machine learning model 410 is trained by training engine 420. Examples of machine learning model 410 include multimodal generative machine learning systems such as those depicted with respect to FIG. 2.

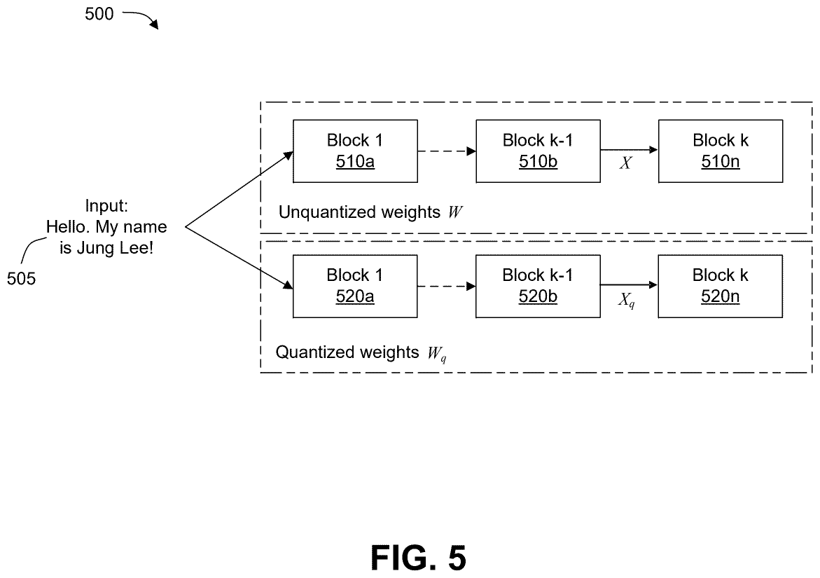

The training engine 420 can tune (e.g., adjust) weights (and in some cases other parameters, such as biases, etc.) of the machine learning model 410 to generate weights 430. Training engine 420 may use any machine learning model training techniques, such as supervised, unsupervised, and reinforcement learning, along with techniques such as linear regression, and so forth. The training engine 420 can output the weights 430 for processing by the quantization engine 440. The quantization engine 440 can quantize the weights 430 according to quantization functions 450, resulting in quantized weights 460. Examples of approaches for performing quantization employed by quantization engine 440 are discussed below, for example, with respect to FIG. 5.

In some examples, quantized weights of a machine learning model can be represented as follows:

$${W}_{q} = {Q}_{Δ} ( W ) = Δ ⌊ \frac{W}{Δ} ⌉$$

is the quantized weight matrix of Wϵ [symbol] ^{m×n}, where:
Δ represents a quantization step size,

$$Δ = \frac{max ( W ) - min ( W )}{{2}^{b} - 1} ∈ {ℝ}_{> 0}^{m \times k} ( here , k = \frac{n}{group\_size} ) ,$$

group_size=n for per-channel quantization (k=1) or
group_size=64 for blockwise quantization, and
b represents a number of bits of quantization.

The value group_size can be adjusted, for example, to 32, 128, or other value. The term max(W) represents a maximum value of the values of weight matrix W and the term min(W) represents a minimum value of the values of weight matrix W. The values of weight matrix W are floating point values.

As discussed below, the systems and techniques described herein relate to minimization of an error measurement associated with quantization. In some examples, an error measurement may be calculated as a mean-squared error, layer by layer as follows:

$${‖ {W}^{( l )} X - {W}_{q}^{( l )} X ‖}_{F}^{2}$$

layer-by-layer, where
w^{(l)} represents a linear layer like a query projection.

Other approaches to calculating error are possible. As discussed herein, by focusing on optimization of quantization parameters for one layer at a time, traditional approaches fail to consider cross-layer dependency of layers of a machine learning system or model, which may result in reduced performance when weights are quantized.

As such, in some cases, the systems and techniques described herein perform block-by-block optimization of quantization. Using a transformer architecture for illustrative purposes, a “block” can refer to a transformer block k including self-attention layer(s) and/or multilayer perceptron (MLP) layer(s). For instance, mean square error (mse) may be minimized on a block-by-block basis, represented as follows:

$$m se = {W}_{q}^{( b )} = {min}_{{W}_{q}} {‖ {W}^{( b )} X - {W}_{q}^{( b )} {X}_{q} ‖}_{F}^{2} ,$$

where:
X_{q} are the quantized outputs of a given transformer block k−1.
W^{(b)} represents the original floating point weight parameters of a block.

$${W}_{q}^{( b )} :$$

Quantized weight parameters of the block k.

In such examples, transformer blocks 1, . . . , k−1 are all quantized. The quantized weights

$${W}_{q}^{( b )}$$

can be obtained sequentially by minimizing the mean squared error with respect to

$${W}_{q}^{( b )}$$

for k=1, 2, . . . and so forth. Such an approach may be referred to as block-wise knowledge distillation (BKD). BKD attempts to quantize the k-th block on a sequential basis. For instance, for a llama 3.2 model with 3 billion parameters, k=1 . . . 28. FIG. 5, described below, depicts an example of BKD. The mean square error may be calculated on a block-by-block basis.

FIG. 5 is a block diagram of a system 500 for quantization of weights of multiple blocks of a machine learning model, in accordance with aspects of the disclosure. In system 500, various blocks 510a, 510b, and 510n and 520a, 520b, and 520n of a machine learning model (or system), their outputs, and associated weights are shown. While three blocks associated with unquantized weights and three blocks associated with quantized weights are discussed, any number of blocks is possible.

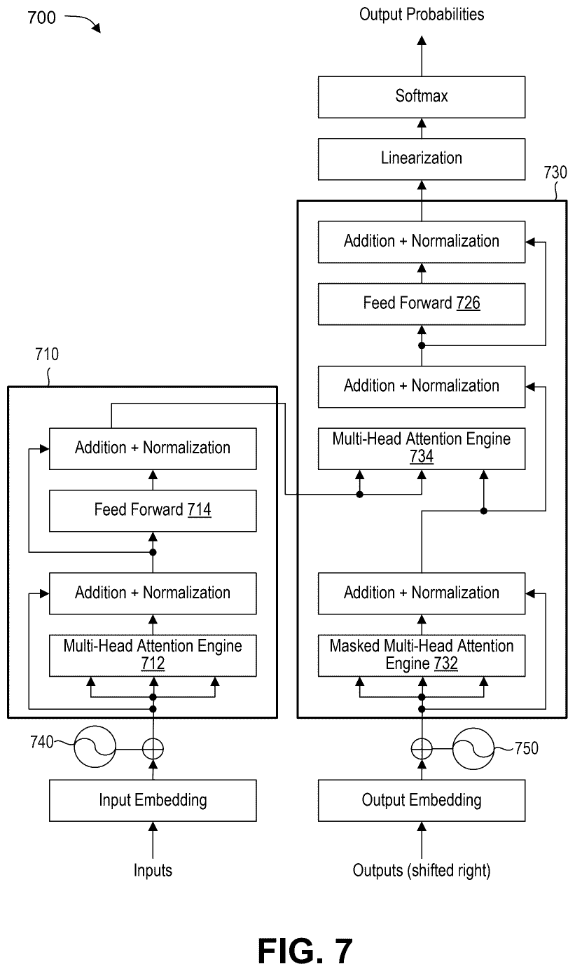

Blocks 510a-510n have 32-bit floating point (e.g., 32-bit) non-quantized weights W (e.g., weights having 32-bit floating point values or other floating point values), whereas blocks 520a-520n have quantized weights W_{q} (e.g., weights quantized to Int4 format, Int8 format, Int16 format, etc.). The blocks may be blocks of a transformer model, for instance as discussed with respect to FIG. 7, or of any other type of machine learning model or system. The weights may be quantized using any quantization technique, such as the quantization techniques described herein.

As shown in FIG. 5, an input 505 is provided to blocks 510a-510n, which operate with unquantized weights. The input 505 is shown in FIG. 5 as a text input (“Hello. My name is Jung Lee”). In other examples, the input 505 can include other types of input, such as images, a combination of text and images, and/or other type of input. Input 505 is also provided to blocks 520a-520n, which operate with quantized weights. At each block k of the blocks 510a-510n and the blocks 520a-520n, an error calculation is made between an output value X, resulting from application of quantized weights W_{q} of the blocks 520a-520n to the input to that block k and the output value X resulting from application of the non-quantized weights W of the blocks 510a-510n to the input to that block k.

In some cases, the error calculation between the output value X_{q} and the output value X is a mean-squared error. For instance, the mean squared error may be represented as follows:

$${‖ {W}^{( b )} X - {W}_{q}^{( b )} {X}_{q} ‖}_{F}^{2}$$

The weights W^{(b)} are original weight parameters of block k,

$${W}_{q}^{( b )}$$

are quantized weight parameters of block k, and X_{q} is an output of quantized transformer block k−1 (e.g., from one of the blocks 520a-520n illustrated in FIG. 5). Other error metrics can also be used. The system 500 can minimize the error.

Various approaches are possible with respect to calculating the quantized weights

$${W}_{q}^{( b )} .$$

Each of these quantization techniques may have respective advantages and disadvantages. In a first approach, the quantized weights are calculated as follows:

$${W}_{q} = Δ ( ⌊ \frac{W}{Δ} ⌋ + h ( V ) )$$

where Vϵ [symbol] ^{m×n} and a certain function h(⋅)ϵ[0,1]; where
V represents a continuous variable that is optimized or learned.

The mean squared error can then be minimized with respect to V. Such an approach may perform well for some models (e.g., for Convolutional Neural Networks (CNNs)) but may face challenges in quantizing other types of models (e.g., LLMs). Such variation in performance may be due to the above-described approach fixing the variable Δ when minimizing the error value but adding

$$h ( V ) ∈ {ℝ}_{[ 0 , 1 ]}^{m \times n}$$

to W forces W to be rounded either up or down only. Such an approach may result in increased errors, such as in LLMs.

Various other approaches may be used to enable adaptive scaling of A or W beyond rounding either up or down only. In another example, the quantized weights are calculated as follows:

$${W}_{q} = Δ ⌊ \frac{W / S}{δ * Δ} ⌉ where :$$

S is a scaling matrix, initialized as

$$S = {[ 1 ]}_{m \times n} ∈ {ℝ}_{> 0}^{m \times n}$$

and
δ is a weight scaling factor, initialized as

$$δ = {[ 1 ]}_{m \times k} ∈ {ℝ}_{> 0}^{m \times k}$$

The mean squared error can then be minimized with respect to Δ, S, and δ. However, such an approach has disadvantages. For example, the above-noted approach enables adaptive scaling of W with the element-wise scale(S) and channel-wise scale (δ), but FlexRound directly learns Δ, which could yield unsatisfactory accuracy.

In another approach, the quantized weights are calculated as follows:

$${W}_{q} = Δ ⌊ \frac{W}{Δ} ⌉ where Δ = \frac{γ * max ( W ) - β * min ( W )}{{2}^{b} - 1} where :$$

γ, β are weight clipping threshold values, defined as: γ,

$$β = {[ 1 ]}_{m \times k} ∈ {ℝ}_{[ 0 , 1 ]}^{m \times k} .$$

The mean squared error can be minimized with respect to γ and β. Instead of directly updating the quantization step size Δ, such an approach enables adaptive scaling of min(W) and max(W) (i.e., γ and β) for determining the optimal weight clipping threshold. Adaptive scaling of W beyond rounding up or down is also necessary to perform further optimizations.

As discussed, the systems and techniques described herein provide improvements relative to existing solutions. In an aspect, the quantized weights may be calculated as follows:

$${W}_{q} = Δ ⌊ \frac{W / S}{δ * Δ} ⌉ , where$$

$$Δ = \frac{γ * max ( W ) - β * min ( W )}{{2}^{b} - 1} , and where :$$

$$γ , β = {[ 1 ]}_{m \times k} ∈ {ℝ}_{[ 0 , 1 ]}^{m \times k}$$

$$S = {[ 1 ]}_{m \times n} ∈ {ℝ}_{> 0}^{m \times n} and δ = {[ 1 ]}_{m \times k} ∈ {ℝ}_{[ 0 , 1 ]}^{m \times k}$$

As discussed above, W_{q} are quantized weight parameters, b represents a number of bits of quantization, S is a scaling matrix, δ is a weight scaling factor, and γ and β are weight clipping threshold values. The mean squared error (or other error metric) can be minimized with respect to γ, β, S, and δ.

In some aspects, instead of updating γ and β within [0,1] using the sigmoid function, the systems and techniques described herein can use the exponential function to allow γ and β to be learned within [0, ∞) (from 0 to any value larger than 0), providing a broader range than existing solutions. In such aspects, the quantized weights may be calculated as follows:

$${W}_{q} = Δ ⌊ \frac{W / S}{δ * Δ} ⌉ , where$$

$$Δ = \frac{γ * max ( W ) - β * min ( W )}{{2}^{b} - 1} , and where :$$

$$γ , β = {[ 1 ]}_{m \times k} ∈ {ℝ}_{> 0}^{m \times k}$$

$$S = {[ 1 ]}_{m \times n} ∈ {ℝ}_{> 0}^{m \times n} and δ = {[ 1 ]}_{m \times k} ∈ {ℝ}_{> 0}^{m \times k}$$

The systems and techniques provide various advantages. For instance, the systems and techniques can be effective for per channel quantization of certain layers of machine learning models or systems, such as transformer decoder layers. The systems and techniques can provide significant benefits in power and lower latency as compared to prior solutions.

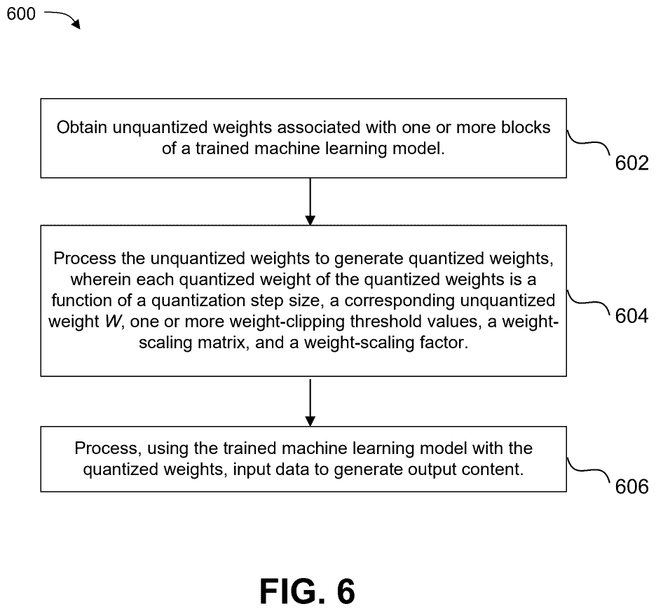

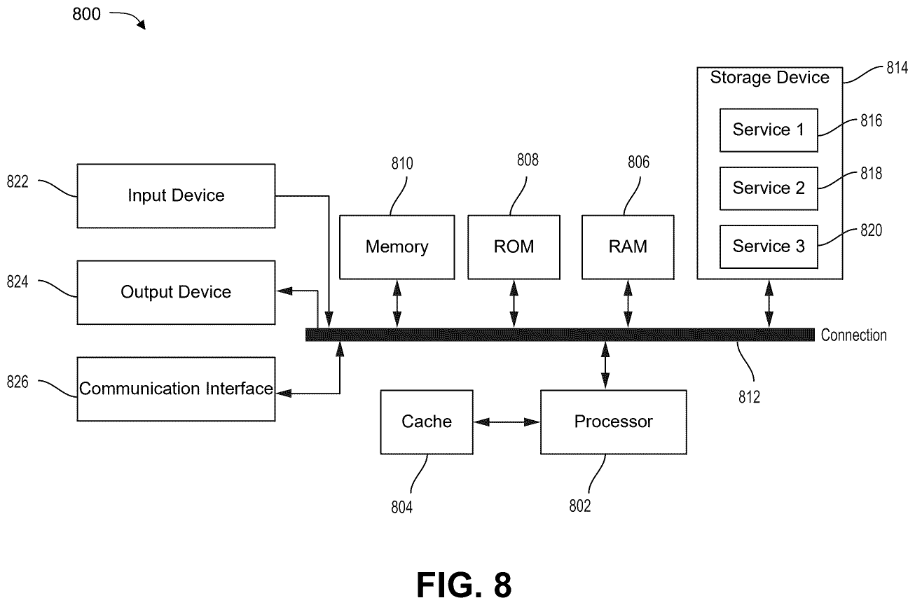

FIG. 6 is a flow diagram illustrating an example of a process for quantization of weights of machine learning models, in accordance with aspects of the disclosure. The process 600 (or any other described herein) can be performed by a computing device (or apparatus) or a component (e.g., the system 400 of FIG. 4 or one or more components thereof, the system 500 of FIG. 5 or one or more components thereof, computing system 800 of FIG. 8 or one or more components thereof, one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAS, programmable logic devices, discrete gates or transistor logic components, discrete hardware components, etc., an ML system or neural network model, any combination thereof, and/or other component or system) of the computing device. The operations of the process 600 may be implemented as software components that are executed and run on one or more processors (e.g., CPU, GPU, DSP, NPU or neural engine, SoC, the processor 802 of FIG. 8, and/or other processor(s)).

In some aspects, at block 602, the computing device (or component thereof) may obtain unquantized weights associated with one or more blocks of a trained machine learning model. The unquantized weights may be generated by a training algorithm.

At block 604, the computing device (or component thereof) may process the unquantized weights to generate quantized weights W_{q}, wherein each quantized weight of the quantized weights is a function of a quantization step size Δ, a corresponding unquantized weight W, one or more weight-clipping threshold values γ and β, a weight-scaling matrix S, and a weight-scaling factor δ. The quantized weights may be in integer format and the unquantized weights may be in floating point format.

In an aspect, to process the unquantized weights, the computing device (or component thereof) can minimize a mean squared error of the quantized weights relative to the unquantized weights with respect to the weight-clipping threshold values γ and β, the weight-scaling matrix S, and the weight-scaling factor δ. Minimizing the mean squared error may involve minimizing the mean squared error on a block-by-block basis.

In an aspect, one or more of the weight-scaling matrix S and the weight-scaling factor δ is a matrix of ones. In a further aspect, the weight-scaling matrix S is a first matrix of ones having a first dimension and the weight-scaling factor δ is a second matrix of ones having a dimension equal to a number of blocks and the first dimension.

In an aspect, to generate each quantized weight W_{q}, the computing device (or component thereof) can determine (e.g., calculate) a first quantity including a matrix of the unquantized weights divided by the weight-scaling matrix S. The computing device (or component thereof) can determine (e.g., calculate) a second quantity including the weight-scaling factor δ multiplied by the quantization step size Δ. The computing device (or component thereof) can divide the first quantity by the second quantity to form a third quantity. The computing device (or component thereof) can determine (e.g., calculate) a floor of the third quantity to form a fourth quantity. The computing device (or component thereof) can determine (e.g., calculate) a ceiling of the fourth quantity. The computing device (or component thereof) can multiply the fourth quantity by the quantization step size Δ.

In some cases, the quantization step size is a function of a maximum unquantized weight of the unquantized weights, a minimum unquantized weight of the unquantized weights, and a number of blocks of the trained machine learning model.

In some aspects, the quantization step size is calculated by calculating a first quantity from a multiplication of a weight-clipping threshold value γ (e.g., referred to as a first weight-clipping threshold value) with a minimum unquantized weight of the unquantized weights, calculating a second quantity from a multiplication of a of the weight-clipping threshold value β (e.g., referred to as a second weight-clipping threshold value) with a maximum unquantized weight of the unquantized weights, calculating a third quantity from raising two to a power of a number of blocks, subtracting the second quantity from the first quantity to generate a fourth quantity, and dividing the fourth quantity by the third quantity.

At block 606, the computing device (or component thereof) may process, using the trained machine learning model with the quantized weights, input data to generate output content.

FIG. 7 is a block diagram of an example transformer in accordance with aspects of the disclosure. In a convolutional neural network (CNN) model, the number of operations required to relate signals from two arbitrary input or output positions grows in the distance between positions, which makes learning dependencies at different distant positions challenging for a CNN model. The transformer 700 reduces the operations of learning dependencies by using an encoder 710 and a decoder 730 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In some examples of a transformer, the encoder 710 is composed of a stack of six identical layers and each layer has two sub-layers. The first sub-layer is a multi-head self-attention engine 712, and the second sub-layer is a fully connected feed-forward network 714. A residual connection (not shown) connects around each of the sub-layers followed by normalization.

In the transformer 700, the decoder 730 is also composed of a stack of six identical layers. The decoder also includes a masked multi-head self-attention engine 732, a multi-head attention engine 734 over the output of encoder 710, and a fully connected feed-forward network 726. Each layer includes a residual connection (not shown) around the layer, which is followed by layer normalization. The masked multi-head self-attention engine 732 is masked to prevent positions from attending to subsequent positions and ensures that the predictions at position i can depend only on the known outputs at positions less than i (e.g., auto-regression).

In the transformer 700, the queries, keys, and values are linearly projected by a multi-head attention engine into learned linear projects, and then attention is performed in parallel on each of the learned linear projects, which are concatenated and then projected into final values.

The transformer also includes a positional encoder 740 to encode positions because the model does not contain recurrence and convolution and relative or absolute position of the tokens is needed. For example, the positional encodings are added to the input embeddings at the bottom layer of the encoder 710 and the decoder 730. The positional encodings are summed with the embeddings because the positional encodings and embeddings have the same dimensions. A corresponding position decoder 750 is configured to decode the positions of the embeddings for the decoder 730.

In some aspects, the transformer 700 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 700 can process input sequences of variable length, making it well-suited for natural language processing tasks where input lengths can vary greatly. Additionally, the self-attention mechanism allows the transformer 700 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 8 is a diagram illustrating an example of a system, which may be for example any computing device that may implement components of the system. In particular, FIG. 8 illustrates an example of a computing system 800, which can be for example an internal computing system of any computing device, such as a mobile device, an XR device, a vehicle computing device or system, a remote computing system, a camera, or other device in which the components of the system are in communication with each other using a connection 812. In some cases, the computing system 800 can implement one or more operations described with respect to the system 400 of FIG. 4, the system 500 of FIG. 5, etc. The connection 812 can be a physical connection using a bus, or a direct connection into the processor 802, such as in a chipset architecture. The connection 812 can also be a virtual connection, networked connection, or logical connection.

In some aspects, the computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 800 includes at least one processing unit (a central processing unit (CPU) or processor) 802 and a connection 812 that couples various system components including a system memory 810, such as ROM 808 and RAM 806 to the processor 802. The computing system 800 can include a cache 804 of high-speed memory connected directly with, in close proximity to, or integrated as part of the processor 802.

The processor 802 can include any general purpose processor and a hardware service or software service, such as services 816, 818, and 820 stored in the storage device 814, configured to control the processor 802 as well as a special-purpose processor where software instructions are incorporated into the actual processor design. The processor 802 may essentially be a completely self-contained computing system, containing multiple cores or processors, a bus, memory controller, cache, etc. A multi-core processor may be symmetric or asymmetric.

To enable user interaction, the computing system 800 includes an input device 822, which can represent any number of input mechanisms, such as a microphone for speech, a touch-sensitive screen for gesture or graphical input, keyboard, mouse, motion input, speech, etc. The computing system 800 can also include an output device 824, which can be one or more of a number of output mechanisms. In some instances, multimodal systems can enable a user to provide multiple types of input/output to communicate with the computing system 800. The computing system 800 can include communications interface 826, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 826 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 814 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 814 can include software services, servers, services, etc., that when the code that defines such software is executed by the processor 802, it causes the system to perform a function. In some aspects, a hardware service that performs a particular function can include the software component stored in a computer-readable medium in connection with the necessary hardware components, such as the processor 802, the connection 812, the output device 824, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 600, and/or other process described herein) may be performed by a computing device or apparatus. In some examples, the process 600 can be performed by a computing device having a computing architecture of the computing system 800 shown in FIG. 8.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, engines, circuits, and algorithm steps described in connection with the aspects disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, engines, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for generating content, comprising: at least one memory; and at least one processor coupled to the at least one memory and configured to: obtain unquantized weights associated with one or more blocks of a trained machine learning model; process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and process, using the trained machine learning model with the quantized weights, input data to generate output content.

Aspect 2. The apparatus of Aspect 1, wherein to process the unquantized weights, the at least one processor is further configured to minimize a mean squared error of the quantized weights relative to the unquantized weights with respect to the one or more weight-clipping threshold values, the weight-scaling matrix, and the weight-scaling factor.

Aspect 3. The apparatus of Aspect 2, wherein to minimize the mean squared error, the at least one processor is further configured to minimize the mean squared error on a block-by-block basis.

Aspect 4. The apparatus of any of Aspects 1-3, wherein one or more of the weight-scaling matrix and the weight-scaling factor is a matrix of ones.

Aspect 5. The apparatus of any of Aspects 1-4, wherein the weight-scaling matrix is a first matrix of ones having a first dimension and the weight-scaling factor is a second matrix of ones having a dimension equal to a number of blocks and the first dimension.

Aspect 6. The apparatus of any of Aspects 1-5, to generate each quantized weight, the at least one processor is further configured to: calculate a first quantity comprising a matrix of the unquantized weights divided by the weight-scaling matrix; calculate a second quantity comprising the weight-scaling factor multiplied by the quantization step size; divide the first quantity by the second quantity to form a third quantity; calculate a floor of the third quantity to form a fourth quantity; calculate a ceiling of the fourth quantity; and multiply the fourth quantity by the quantization step size.

Aspect 7. The apparatus of any of Aspects 1-6, wherein the quantization step size is a function of a maximum unquantized weight of the unquantized weights, a minimum unquantized weight of the unquantized weights, and a number of blocks of the trained machine learning model.

Aspect 8. The apparatus of any of Aspects 1-7, wherein the quantization step size is calculated by: calculating a first quantity from a multiplication of a first weight-clipping threshold value with a minimum unquantized weight of the unquantized weights; calculating a second quantity from a multiplication of a second weight-clipping threshold value with a maximum unquantized weight of the unquantized weights; calculating a third quantity from raising two to a power of a number of blocks; subtracting the second quantity from the first quantity to generate a fourth quantity; and dividing the fourth quantity by the fourth quantity.

Aspect 9. The apparatus of any of Aspects 1-8, wherein the quantized weights are in integer format and the unquantized weights are in floating point format.

Aspect 10. A method for generating content, comprising: obtaining unquantized weights associated with one or more blocks of a trained machine learning model; processing the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and processing, using the trained machine learning model with the quantized weights, input data to generate output content.

Aspect 11. The method of Aspect 10, wherein processing the unquantized weights comprises minimizing a mean squared error of the quantized weights relative to the unquantized weights with respect to the one or more weight-clipping threshold values, the weight-scaling matrix, and the weight-scaling factor.

Aspect 12. The method of Aspect 11, wherein minimizing the mean squared error comprises minimizing the mean squared error on a block-by-block basis.

Aspect 13. The method of any of Aspects 10-12, wherein one or more of the weight-scaling matrix and the weight-scaling factor is a matrix of ones.

Aspect 14. The method of any of Aspects 10-13, wherein the weight-scaling matrix is a first matrix of ones having a first dimension and the weight-scaling factor is a second matrix of ones having a dimension equal to a number of blocks and the first dimension.

Aspect 15. The method of any of Aspects 10-14, wherein generating each quantized weight comprises: calculating a first quantity comprising a matrix of the unquantized weights divided by the weight-scaling matrix; calculating a second quantity comprising the weight-scaling factor multiplied by the quantization step size; dividing the first quantity by the second quantity to form a third quantity; calculating a floor of the third quantity to form a fourth quantity; calculating a ceiling of the fourth quantity; and multiplying the fourth quantity by the quantization step size.

Aspect 16. The method of any of Aspects 10-15, wherein the quantization step size is a function of a maximum unquantized weight of the unquantized weights, a minimum unquantized weight of the unquantized weights, and a number of blocks of the trained machine learning model.

Aspect 17. The method of any of Aspects 10-16, wherein calculating the quantization step size comprises: calculating a first quantity from a multiplication of a first weight-clipping threshold value with a minimum unquantized weight of the unquantized weights; calculating a second quantity from a multiplication of a second weight-clipping threshold value with a maximum unquantized weight of the unquantized weights; calculating a third quantity from raising two to a power of a number of blocks; subtracting the second quantity from the first quantity to generate a fourth quantity; and dividing the fourth quantity by the fourth quantity.

Aspect 18. The method of any of Aspects 10-17, wherein the quantized weights are in integer format and the unquantized weights are in floating point format.

Aspect 19. A non-transitory computer-readable medium is provided that has stored thereon instructions that, when executed by one or more processors, cause the one or more processors to: obtain unquantized weights associated with one or more blocks of a trained machine learning model; process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and process, using the trained machine learning model with the quantized weights, input data to generate output content.

Aspect 20. The non-transitory computer-readable medium of Aspect 19, wherein to process the unquantized weights, the one or more processors are further configured to minimize a mean squared error of the quantized weights relative to the unquantized weights with respect to the one or more weight-clipping threshold values, the weight-scaling matrix, and the weight-scaling factor.

Aspect 21. The non-transitory computer-readable medium of any of Aspects 19-20, wherein the weight-scaling matrix is a first matrix of ones having a first dimension and the weight-scaling factor is a second matrix of ones having a dimension equal to a number of blocks and the first dimension.

Aspect 22. The non-transitory computer-readable medium of any of Aspects 19-21, to generate each quantized weight, the one or more processors are further configured to: calculate a first quantity comprising a matrix of the unquantized weights divided by the weight-scaling matrix; calculate a second quantity comprising the weight-scaling factor multiplied by the quantization step size; divide the first quantity by the second quantity to form a third quantity; calculate a floor of the third quantity to form a fourth quantity; calculate a ceiling of the fourth quantity; and multiply the fourth quantity by the quantization step size.

Aspect 23. The non-transitory computer-readable medium of any of Aspects 19-22, wherein the quantization step size is calculated by: calculating a first quantity from a multiplication of a first weight-clipping threshold value with a minimum unquantized weight of the unquantized weights; calculating a second quantity from a multiplication of a second weight-clipping threshold value with a maximum unquantized weight of the unquantized weights; calculating a third quantity from raising two to a power of a number of blocks; subtracting the second quantity from the first quantity to generate a fourth quantity; and dividing the fourth quantity by the fourth quantity.

Aspect 24: An apparatus for comprising one or more means for performing operations according to any of Aspects 10-18.

What is claimed is:

1. An apparatus for generating content, comprising:
at least one memory; and
at least one processor coupled to the at least one memory and configured to:
obtain unquantized weights associated with one or more blocks of a trained machine learning model;
process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and
process, using the trained machine learning model with the quantized weights, input data to generate output content.

2. The apparatus of claim 1, wherein to process the unquantized weights, the at least one processor is further configured to minimize a mean squared error of the quantized weights relative to the unquantized weights with respect to the one or more weight-clipping threshold values, the weight-scaling matrix, and the weight-scaling factor.

3. The apparatus of claim 2, wherein to minimize the mean squared error, the at least one processor is further configured to minimize the mean squared error on a block-by-block basis.

4. The apparatus of claim 1, wherein one or more of the weight-scaling matrix and the weight-scaling factor is a matrix of ones.

5. The apparatus of claim 1, wherein the weight-scaling matrix is a first matrix of ones having a first dimension and the weight-scaling factor is a second matrix of ones having a dimension equal to a number of blocks and the first dimension.

6. The apparatus of claim 1, to generate each quantized weight, the at least one processor is further configured to:
calculate a first quantity comprising a matrix of the unquantized weights divided by the weight-scaling matrix;
calculate a second quantity comprising the weight-scaling factor multiplied by the quantization step size;
divide the first quantity by the second quantity to form a third quantity;
calculate a floor of the third quantity to form a fourth quantity;
calculate a ceiling of the fourth quantity; and
multiply the fourth quantity by the quantization step size.

7. The apparatus of claim 1, wherein the quantization step size is a function of a maximum unquantized weight of the unquantized weights, a minimum unquantized weight of the unquantized weights, and a number of blocks of the trained machine learning model.

8. The apparatus of claim 1, wherein the quantization step size is calculated by:
calculating a first quantity from a multiplication of a first weight-clipping threshold value with a minimum unquantized weight of the unquantized weights;
calculating a second quantity from a multiplication of a second weight-clipping threshold value with a maximum unquantized weight of the unquantized weights;
calculating a third quantity from raising two to a power of a number of blocks;
subtracting the second quantity from the first quantity to generate a fourth quantity; and
dividing the fourth quantity by the fourth quantity.

9. The apparatus of claim 1, wherein the quantized weights are in integer format and the unquantized weights are in floating point format.

10. A method for generating content, comprising:
obtaining unquantized weights associated with one or more blocks of a trained machine learning model;
processing the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and
processing, using the trained machine learning model with the quantized weights, input data to generate output content.

11. The method of claim 10, wherein processing the unquantized weights comprises minimizing a mean squared error of the quantized weights relative to the unquantized weights with respect to the one or more weight-clipping threshold values, the weight-scaling matrix, and the weight-scaling factor.

12. The method of claim 11, wherein minimizing the mean squared error comprises minimizing the mean squared error on a block-by-block basis.

13. The method of claim 10, wherein the weight-scaling matrix is a first matrix of ones having a first dimension and the weight-scaling factor is a second matrix of ones having a dimension equal to a number of blocks and the first dimension.

14. The method of claim 10, wherein generating each quantized weight comprises:
calculating a first quantity comprising a matrix of the unquantized weights divided by the weight-scaling matrix;
calculating a second quantity comprising the weight-scaling factor multiplied by the quantization step size;
dividing the first quantity by the second quantity to form a third quantity;
calculating a floor of the third quantity to form a fourth quantity;
calculating a ceiling of the fourth quantity; and
multiplying the fourth quantity by the quantization step size.

15. The method of claim 10, wherein calculating the quantization step size comprises:
calculating a first quantity from a multiplication of a first weight-clipping threshold value with a minimum unquantized weight of the unquantized weights;
calculating a second quantity from a multiplication of a second weight-clipping threshold value with a maximum unquantized weight of the unquantized weights;
calculating a third quantity from raising two to a power of a number of blocks;
subtracting the second quantity from the first quantity to generate a fourth quantity; and
dividing the fourth quantity by the fourth quantity.

16. A non-transitory computer-readable medium is provided that has stored thereon instructions that, when executed by one or more processors, cause the one or more processors to:
obtain unquantized weights associated with one or more blocks of a trained machine learning model;
process the unquantized weights to generate quantized weights, wherein each quantized weight of the quantized weights is a function of a quantization step size, a corresponding unquantized weight, one or more weight-clipping threshold values, a weight-scaling matrix, and a weight-scaling factor; and
process, using the trained machine learning model with the quantized weights, input data to generate output content.

17. The non-transitory computer-readable medium of claim 16, wherein to process the unquantized weights, the one or more processors are further configured to minimize a mean squared error of the quantized weights relative to the unquantized weights with respect to the one or more weight-clipping threshold values, the weight-scaling matrix, and the weight-scaling factor.

18. The non-transitory computer-readable medium of claim 16, wherein the weight-scaling matrix is a first matrix of ones having a first dimension and the weight-scaling factor is a second matrix of ones having a dimension equal to a number of blocks and the first dimension.

19. The non-transitory computer-readable medium of claim 16, to generate each quantized weight, the one or more processors are further configured to:
calculate a first quantity comprising a matrix of the unquantized weights divided by the weight-scaling matrix;
calculate a second quantity comprising the weight-scaling factor multiplied by the quantization step size;
divide the first quantity by the second quantity to form a third quantity;
calculate a floor of the third quantity to form a fourth quantity;
calculate a ceiling of the fourth quantity; and
multiply the fourth quantity by the quantization step size.

20. The non-transitory computer-readable medium of claim 16, wherein the quantization step size is calculated by:
calculating a first quantity from a multiplication of a first weight-clipping threshold value with a minimum unquantized weight of the unquantized weights;
calculating a second quantity from a multiplication of a second weight-clipping threshold value with a maximum unquantized weight of the unquantized weights;
calculating a third quantity from raising two to a power of a number of blocks;
subtracting the second quantity from the first quantity to generate a fourth quantity; and
dividing the fourth quantity by the fourth quantity.
